(19) United States
(12) Patent Application Publication
(10) Pub. No.: US 2004/0064453 A1
(43) Pub. Date: Apr. 1, 2004

(54) Large-scale hierarchical identification and verification for secured ingress and egress using biometrics

(76) Inventors: Antonio Ruiz, Poughguag, NY (US); John Vance Meyers, Edgewater, MD (US)

Correspondence Address: MATTINGLY, STANGER & MALUR, P.C., 1800 DIAGONAL ROAD, SUITE 370, ALEXANDRIA, VA, 22314, US

(21) Appl. No.: 10/671,530

(22) Filed: Sep. 29, 2003

Related U.S. Application Data
(60) Provisional application No. 60/414,054, filed on Sep. 27, 2002.

(51) Int. Cl. G06F 7/00

(52) U.S. Cl. 707/9

(57) ABSTRACT

A method and a system for verification and identification of individuals using a biometric means and other system-related means that depend on a hierarchical database of stored or acquired information for large-scale population ingress and egress in any secured environment. The identification and verification capability is performed based on multiple and hierarchical profiles which are presented and activated at entry/exit points and are comprised of database parameters related to types of populations per environment, policies, procedures, and controls related to those populations effective at the time of operation; allocated privileges given to members of the end-user population; ID card information that includes biometric information that is self-encrypted; communications environment for the peripheral systems; computing system environment for the peripheral systems; dynamic rules that depend on applications running locally or remotely; and various other parameters related to administrator and user populations.

### CROSS-REFERENCES TO RELATED APPLICATIONS

This application claims the benefit of U.S. Provisional Patent Application No. 60/414,054 filed Sep. 27, 2002.

### BACKGROUND OF THE INVENTION

1. Field of the Invention

This invention relates to security and access-control systems, and more particularly, to security and access-control systems that use biometric information for identifying and authorizing individuals for controlling ingress and egress to and from locations.

2. Description of the Related Art

The current environment in many enterprises and in many countries makes it mandatory that a highly reliable and efficient method of controlling physical and logical ingress and egress to secured or regulated locations be implemented to protect the assets (both tangible assets, e.g., buildings, equipment, etc., and non-tangible assets, e.g., information, data, trade secrets, etc.) and personnel of these locations. Various systems have evolved separately over time to cover all the component ingredients to create potentially more powerful solutions to the above problem. The evolution of computing systems, electronics technologies, software applications, new algorithms, data encryption methods, databases, communications, and other subsystem components are all part of prior art technologies currently available in various forms. While these systems have evolved and can be aggregated into suitable solutions for ingress and egress applications with biometric verification and identification, many of the processes required for implementing static and dynamic rules, policies, and procedures associated with such systems are still carried out manually. The increased complexity of large populations and large-scale distributed systems makes it extremely difficult to operate a large system with manual enforcement of rules, policies, and procedures. Thus, there is a need for an apparatus, method and system whereby automated static and dynamic rules, policies, and procedures are fully implemented into these systems to remove the requirement for manual enforcement. Additionally, there is a need to incorporate these rules, policies and procedures into hierarchical profiles (henceforth referred to as HPs) for each subsystem of the system and for operational considerations specific to both end-users and the system operators/administrators.

The prior art provides extensive examples of biometric means for verification and identification of individuals. Of these biometric identifiers, fingerprint data is one of the most reliable and yet unobtrusive means for biometric identification. Accordingly, the present invention employs fingerprint verification and identification using the core vector technology (CVT) method. This vector technology method and similar methods for fingerprint identification, classification, and storage technology are discussed in U.S. Pat. Nos. 6,330,674; 6,195,447; 6,185,316; 6,125,192; 6,002,787; 5,982,913; 5,745,900; 5,659,626; and 4,790,564, the disclosures of which are incorporated herein by reference in their entirety. The CVT fingerprint verification and identification method with its high accuracy is the primary means of authentication used by the present invention, with any other preferred biometric identification method used as a secondary means of identification.

The primary and secondary means of biometric identification are the basic elements of the system of the invention. Various systems and methods for operating biometric access-control and security systems are set forth in U.S. Pat. Nos. 6,289,111; 6,141,753; 6,052,468; 5,995,630; 5,790,668; 5,748,765; 5,712,912; 5,631,971; and 5,513,272, the disclosures of which are incorporated herein by reference in their entirety. The method and system described herein further enhance the verification and identification according to specific population and privilege criteria set forth. We have selected and identified herein a preferred primary biometric means and prior method and apparatus for highly accurate, realizable, and unobtrusive means for biometric identification as implemented in the CVT method for fingerprint analysis and identification. CVT generates a single reference number for every enrolled fingerprint and provides the first of its kind failure acceptance rate (FAR) of zero (or FAR=0) in one-to-many identification applications. Prior art also describes means for secondary biometrics that can be used with the CVT method and system to include the following: iris scan, handprint geometry, facial recognition, voice recognition, and the like, having a FAR near or equal to zero.

Prior art also describes a means for capturing the biometric information with high quality for building a reference database that contains a single biometric instance of CVT per fingerprint (with one or more fingerprints belonging to the same individual) per individual in the database. Hereinafter, this database will be referred to as the “reference database.” Additionally, the prior art also discloses methods and means for eliminating duplicate entries in existing databases of fingerprints CVTs, or other biometrics.

Additionally, the prior art describes several methods of obtaining CVTs from various fingerprint scan technologies available according to the level of precision desired in the system for reference enrollment and for readers. These scanners allow for high quality identification and verification to the desired level realizable by the available technology. The prior art also describes various methods for storing privileges or classes of individuals who are the target of verification and identification by the method and system described herein. In addition, the prior art describes various methods, apparatuses, systems, implementations, and preferred embodiments for various means of transmission of data, information, databases, etc., across multiple media to exchange information; and various methods, apparatuses, systems, implementations, and preferred embodiments for various means of computing information in local, remote, and/or centralized environments.

Further, the prior art describes various methods, apparatuses, systems, implementations, and preferred embodiments for various means for storage of information in local, remote, and/or centralized environments, and the means and the technology for storing all digital information used by the present invention (including biometrics information, images, videos, entry/exit data, time, location, transaction data, activity data, etc.) in a distributed relational database, using all the information in the links of the resulting relational database, querying semantics for a database, applications for database querying, applications for database management, applications for database optimization, database object extensions, and all operations pertinent for operating, managing, and obtaining information from a distributed relational database, including a multimedia-rich database, on a timely basis across a distributed or centralized environment using the proper communications.

In addition, the prior art describes the means and the technology for computing to run centralized or distributed applications that can use the relational database resulting from the aggregation of information obtained from the database or from end-users. The prior art also describes various methods, apparatuses, systems, implementations, and preferred embodiments for various means of an identification card or carried document that contains pertinent information about the individual and codified/encrypted visible or invisible biometric information about the individual's CVTs that confirms that the CVT scan for that individual belongs to him (independent of his identity). This same means can also carry self-contained codified/encrypted information about the card-holder's privileges of access/entry/exit/passage, and the like.

The prior art also describes various methods, apparatuses, systems, implementations, and preferred embodiments for various means for store and forward selected information in automatic or manual updates to remote cache or storage locations. The prior art also describes various methods, apparatuses, systems, implementations, and preferred embodiments for various means for encrypting information to various standard or proprietary encoding methods using public and or private keys. Additionally, the prior art describes various methods, apparatuses, systems, implementations, and preferred embodiments for various means for hardware, firmware, and/or software computation in various implementations with general purpose processors and/or specialized digital signal processors for the processing of CVT algorithms, sorting algorithms, classification algorithms, or others for the realizable, quick and efficient computational operations required by the system described herein.

### BRIEF SUMMARY OF THE INVENTION

In a first aspect, the invention is directed to a hierarchical system for controlling ingress and egress of large populations to controlled areas or systems. The invention includes an identification instrument whose information and privileges for access, transit, and exit are all kept in records in a distributed database together with profiles for the end-user. Furthermore, this invention describes a method for using fingerprint CVT biometrics as the primary biometric means, and other biometric means as secondary biometric means (e.g., hand geometry, facial recognition, iris scan, and/or voice recognition). The biometric means are used for relating end-user records, activity records, profiles, and privileges together for verification and identification to secure identity and tracking of the end-users in entry, exit, and transit uses of identification instruments. The method and system of the preferred embodiments has applications in the following areas: entry/exit visa systems for tourists, students, migrant workers, diplomatic personnel, flight crews, ship crews, and permanent alien residents; entry/exit system for US citizens when traveling outside the US; driver license or identity card usage and authentication applications; professional or commercial driver (e.g., truck driver, tanker driver, cement mixer driver, taxi driver, bus driver, etc.) usage and authentication systems; secured building area entry/exit/transit ingress and egress usage, tracking and authentication applications for authorized personnel; secured perimeter location entry/exit/transit ingress and egress usage, tracking and authentication applications for authorized personnel; payment systems for entry/exit/transit ingress and egress usage, tracking and authentication applications for authorized personnel; and other for pay or for authorized user system applications for entry/exit/transit ingress and egress usage, tracking and authentication.

Under one embodiment, the system may include some or all of the following elements:

a. A Core Vector Technology (henceforth called CVT) fingerprint acquisition system that generates unique CVTs per individual for high quality reference databases.

b. An optional secondary biometric acquisition system for use together with a primary fingerprint biometric system or in the absence of a fingerprint system.

c. A multiple-identity elimination system for existing fingerprint or secondary biometrics databases.

d. A CVT entry point for operational uses of the system, and, where required, a secondary biometric entry point if there is a secondary biometric acquisition system in place.

e. A suitable database and database management system that has relational capabilities so that relational profiles for output and for input can be developed and operated upon so that they serve as profile information for the operations of the system.

f. A suitable communications medium for all ingress and egress points where end-users will operate the system in both operator-attended and unattended modes.

g. A suitable remote peripheral system that may include any or all of the following: acquisition, administration, caching, algorithm computation, ID card computation, information capture, information modification, profile processing application, recording and monitoring capability, data-mining capabilities, dynamic application, and user administration capability according to local or remote administrative policies, procedures, and controls administration and profile management.

h. A suitable highly available, highly reliable, archival-capable, central or distributed master system for reference database captures.

i. A suitable highly available, highly reliable, archival-capable, central or distributed master system for acquisition, administration, caching, algorithm computation, ID card computation, information capture, information modification, profile processing application, recording and monitoring capability, data-mining capabilities, dynamic application, and user administration capability in support of or on behalf of a remote peripheral system.

j. A suitable database archival system that archives: all reference information; all ingress/egress transaction record keeping information; all events information (including digital image capture in single or multiple frames); all periodic information uploads from the peripheral system; all administrative events and logs of administration operations and changes; and all ID card changes and modifications. The system should also provide backup and download operation in case of initialization, rebuild, or resynchronization/reconciliation of all databases.

k. A suitable computational means to maximize performance in peripheral locations and achieve an optimal trade-off of computation versus communication means at every peripheral location, allowing for multiple implementations with both manned and unmanned peripheral locations. The system can include different levels of security and different profile rules for speeding up the ingress or egress process depending on various rules according to time of day, day of the week, shift, expected volume of entry or exit, and various other criteria for security performance and system performance.

l. A suitable scanning means to obtain CVTs according to the type of peripheral location (e.g., manned vs. unmanned, high traffic vs. low-traffic, time of day, security level, etc.)

m. A suitable secondary biometrics means for enrollment, capture, input, verification, and identification in support of the primary biometric or as replacement for primary biometric means.

In an additional aspect referred to as “compartmentailzation”, the invention may include a means and a method for dividing the reference database into multiple categories or compartments of the relational distributed database according to the system profile criteria of user activity, verification, and/or identification effective at the time of usage. The invention may provide a means and a method for encrypting the primary biometric fingerprint information by the use of CVT inputs as the encoding key, which can in turn be used as a self-enabled private or public key for purposes of verification and validation. The CVT to be used for encryption need not be revealed in the ID card because it can be computed upon presentation of one or more fingerprints.

Under yet another aspect, the invention may include a reliable means and a method for receiving and computing CVTs and comparing them against the information on an ID card, a local database, a local cache, and/or a remote database. The comparison is performed in a hierarchical manner according to the privileges sought, the system profile of security alerts, the secured level being sought by the individual, the level of activity in the system, the type of ID card systems used to enter the biometric or other information, and any other application-driven or administrator-driven criteria or combinations thereof according to static and dynamic rules, policies, and procedures captured in hierarchical profiles.

The invention may further include a means and a method for profiling the subsystems, including the different types of CVT databases, different types of privileges, different types of users, different types of dynamic or static security criteria, different types of administrator/operator users, different types of communications environments, and combining all these factors into a master active system. This may include a means and method for entering profile information into all the databases and relating them to each other to present an administrator and end-users with a user friendly interface that presents an operational interface for the system while concealing all algorithms and system details from the administrator and the end-user. This may include a means and a method for administrators to configure certain profile parameters according to security administration policy and guidelines. Further included may be a means for user administration accountability through monitoring, login, and recording by security administration management during changes or enforcement of any system configuration profiles.

Additionally, the invention may include a means and a method for storing all ingress and egress transaction information with a record of pertinent information including, but not limited to, a digital picture means (static or multiple frames) and adding to the “transaction” database for record keeping and real-time processing and/or offline batch processing and checking. Furthermore, there may be included a means for data mining all activity information separate from any identity information because of the compartmentalization of the database, and a means and a method for data mining the transaction information and developing patterns of ingress and egress activity as required for specific high risk activities or suspect end-users as required by the policies, procedures and controls of the pertinent authorities.

Under yet another aspect, the invention may include a means and a method for ID card issuance, according to the specified profiles, privileges, and information desired on the ID card instrument, using a reliable and highly accurate CVT enrollment system according to the policies, procedures, and controls effective at the time for the target end user or individual. This may incorporate a means and a method for dynamically altering/enhancing/recording information onto the ID card profiles, privileges, and/or information according to policies, procedures, and controls effected by a given security administration program application. The ID card portion of the invention may further include a means and a method for: detecting fraudulent ID cards; detecting unauthorized changes in ID cards; electronic attack protection from ID cards; and detecting lost/stolen ID cards and/or inoperative ID cards. Additionally, the invention may include a means for keeping track of how many ID cards have been issued to any given individual and for de-activating and tracking the lost or stolen ID cards. Also included are a means and a method for secured access to the system so that only authorized administrator users can gain access to operate, manage, control, or otherwise interact with the administration or operation of the system station through the use of an administrator entry with CVT biometric identification and ID card whenever the system needs to be activated, operated, or shut down. The ID card may include encryption of information on the card, and CVT encryption is the preferred encryption method used for any information onboard the ID card and for optional transmission of the system information across the communications network.

Under another aspect, the invention includes a means and a method to implement a preferred embodiment of this invention in an evolutionary and partial way by building upwards with one or a few databases and still be able to perform verification and identification within the desired classes of users covering the total or a partial scope of that database. This will permit implementation of the preferred embodiment of the invention by performing verification and identification in any given subset of the population (e.g., for every new student or resident visa holder; tourists entering a particular area of the U.S.; all IT security administration personnel with access to computer systems and networking equipment in access controlled rooms; and the like). These and other features and advantages of the present invention will become apparent to those of ordinary skill in the art in view of the following detailed description of the preferred embodiments.

### BRIEF DESCRIPTION OF THE DRAWINGS

The accompanying drawings, in conjunction with the general description given above, and the detailed description of the preferred embodiments given below, serve to illustrate and explain the principles of the preferred embodiments of the best mode of the invention presently contemplated, wherein:

FIG. 1 illustrates a large-scale hierarchical identification and verification system using biometrics;

FIG. 2a illustrates a first embodiment of an ID card as used in the preferred embodiment of the invention;

FIG. 2b illustrates a second embodiment of an ID card as used in the preferred embodiment of the invention;

FIG. 2c illustrates an identity document as used in the preferred embodiment of the invention;

FIG. 3 illustrates processes and information exchange in the method and system of this invention;

FIG. 4 illustrates a summary of hierarchical profile relationships in the present invention; and

FIG. 5 illustrates the profile generation subsystem and management subsystem.

### DETAILED DESCRIPTION OF THE INVENTION

In the following detailed description of the invention, reference is made to the accompanying drawings which form a part of the disclosure, and, in which are shown by way of illustration, and not of limitation, specific embodiments by which the invention may be practiced. In the drawings, like numerals describe substantially similar components throughout the several views. The embodiments illustrated are described in sufficient detail to enable those skilled in the art to practice the invention. Other embodiments may be utilized and derived therefrom, such that structural and logical substitutions and changes may be made without departing from the scope of the invention. The following detailed description, therefore, is not to be taken in a limiting sense, and the scope of the invention is defined only by the appended claims, along with the full range of equivalents to which such claims are entitled.

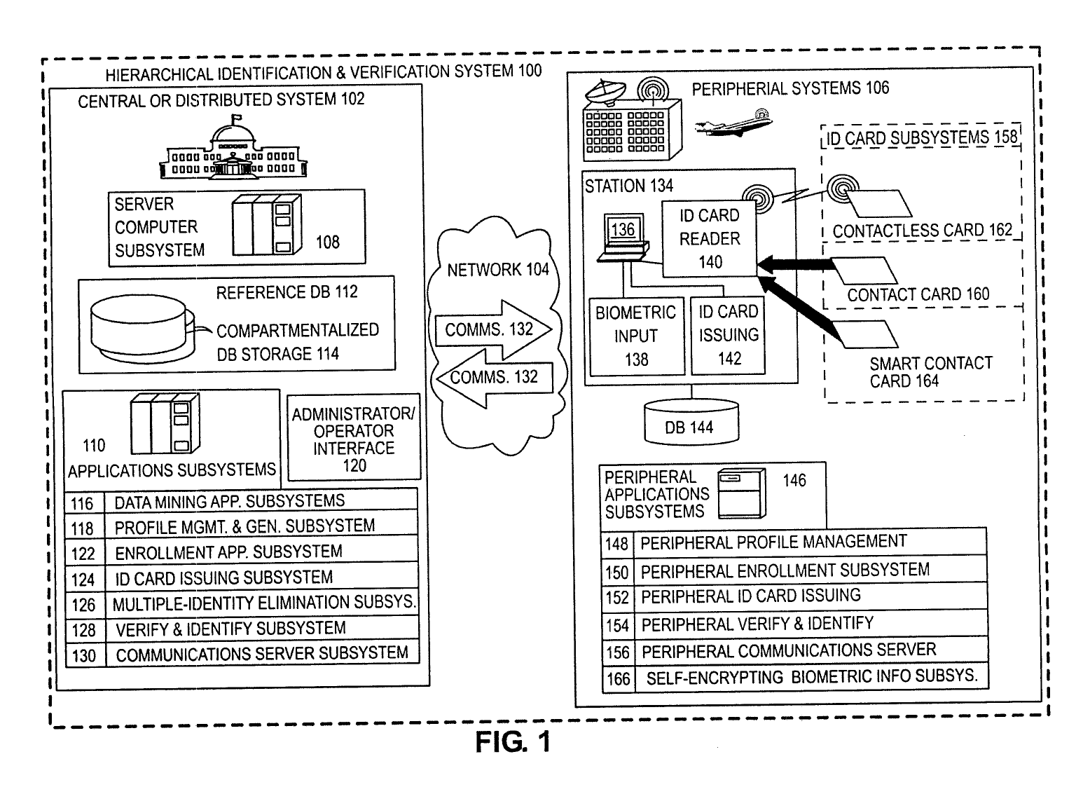

A preferred embodiment of an overall system 100 for hierarchical identification and verification of large-scale populations using biometrics is illustrated in FIG. 1. The overall system 100 illustrated in FIG. 1 is comprised of three primary elements, a central or distributed system 102, a communications network 104, and one or more peripheral systems 106. Each of these primary elements 102, 104, 106 are defined as follows:

1. Central or Distributed System 102 contains and maintains all the reference information and the databases associated with that reference information. Central or distributed system 102 also comprises the archival information for backup and reconciliation in the case that some of the information is lost or destroyed. Central or distributed system 102 has the following sub-elements:

a. Server Computer Subsystems 108 that perform all database maintenance and support operations;

b. A Central or Distributed Application Subsystem 110 that performs all the operations for peripheral systems 106 when peripheral systems 106 must assist or central system operations are required as a result of the hierarchical profiles (HPs);

c. Reference Data Base (DB) 112 that contains all the central or distributed server information pertaining to system 100 in relation to end-users, biometrics, activity records, entry/exit records, HPs, profile rules, enrollment information, and administrator information; (Furthermore, reference DB 112 is virtually compartmentalized into compartmentalized DB storage 114 to allow the separation of data and information so that information can be mined without violating policies, laws, regulations, and rules according to HPs. Reference DB 112 also synchronizes with all the databases in peripheral systems 106, described in more detail below.)

d. Data Mining Application Subsystems 116 that perform all the operations related to: mining the reference data information; mining the information gathered from the peripheral elements defined below; obtaining patterns of ingress and egress; obtaining patterns of activity; deriving rules and procedures for alert and response; and communicating rules to the profile generator;

e. Profile Management and Generator Subsystem 118 that performs the enforcement of: the hierarchical profiles according to the rules, policies, procedures, and controls; data mining generated rules; security administrator commands; environmental rules (e.g., time-of-day, day-of-week, number of users, security alert levels, etc.); and other security priorities in effect at any given time; (Profile generator system 118 derives the target HPs that get used by the peripheral systems 106 and central or distributed system 102. A high-level or privileged administrator is provided a suitable administrator/operator interface 120, such as a graphical user interface (GUI) to create, activate, modify, and plan HPs that can operate under various global or localized conditions pertaining to any and all aspects of the end-to-end system of this invention.)

f. Enrollment Subsystem 122 that allows end-users, administrators, and their associated data to be incorporated into reference DBs 112; (This enrollment subsystem 122 also authorizes the issuance of biometric ID cards according to HPs, as will be discussed in more detail below.)

g. An ID Card Issuing Subsystem 124 that is capable of generating ID cards for immediate issue or for later delivery to end-users (e.g., by mail or for personal pick-up);

h. Multiple-identity Elimination Subsystem 126 that can operate on an existing biometric reference database and eliminate multiple identities that may have resulted from a previous less-accurate biometric system enrollment process or from non-synchronized enrollment systems; (Multiple-identity elimination subsystems 126 clean up reference DB 112 to allow the CVT many-to-many and 1-to-many identification processes to achieve true single fingerprint biometric reference for any given reference to a fingerprint in reference DB 112.)

i. Verification and Identification Subsystem 128 which performs all the biometric verification and identification services for the end-user and administrator populations in central or distributed server subsystem 108; (The services provided by verification and identification subsystem 128 operate on biometric inputs or data coming from peripheral systems 106 or central or distributed system 102.) and

j. Communications Server Subsystem 130 with encryption/decryption that performs the encrypted exchange of information from central or distributed systems 102 to peripheral systems 106, and vice versa.

2. Communications Network 104 permits communications 132 among the elements of overall system 100. This communications network 104 may be comprised of many networking options that include the following: land lines, wireless, satellite, virtual private networks, fiber, public service provider services, local area networks, and the like. Furthermore, communications network 104 can also comprise a multiplicity of communications options for high bandwidth throughput, higher performance, high availability, and guaranteed bandwidth. Communications network 104 also makes use of encryption technology, including, but not limited to, encrypted broadcast or multicast for periodic dissemination of new reference information, new HPs, new administration orders that activate one or more HPs for various types of end-users (e.g., student visa holders must be given access only after checking with the reference system, or a new system administrator must see his manager before entering the secured perimeter premises, or a particular tourist visa holder must be interviewed and his answers recorded and/or checked against the reference database before allowing entry or exit), and emergency dissemination of the same information.

Communications network 104 is the lifeline of overall system 100. However, communications network 104 may have operational limitations that are specific to a particular peripheral environment. These limitations are overcome by an opportunistic means of communication that allows for enough reference and profile information to be downloaded to the target peripheral locations, and with this information, the peripheral locations are capable of stand-alone operation (i.e., no communication to central or distributed system 102), or even unmanned operation for certain periods of time (e.g., for the day, for the next two hours of high volume, or the like).

3. Peripheral System(s) 106 are the main end-user points of operation for the overall hierarchical identification and verification system 100. Peripheral systems 106 could be large operational centers in their own right (e.g., large airport, ferry/ship port of entry, large computing center, large secured perimeter government complex, a higher security perimeter within another perimeter, etc.) or they could be small and unmanned (e.g., Canadian border frequent business traveler gate, border gate for migrant workers, entry/exit gateway for employee in government secured facility, ingress/egress point for network operations center, etc.) and they are comprised of the following sub-elements:

a. A Peripheral Systems Station 134 that is comprised of a computing system 136 with a biometrics input capability 138, an ID card reading capability 140, and an optional ID card issuing capability 142; (The implementation of the biometrics processing capability can be made available as software in a computer, firmware in a special purpose processor (e.g., a micro-controller or digital signal processor), or in some custom FPGA (Field Programmable Gate Array) or VLSI (Very Large Scale Integration) chip. Furthermore, peripheral systems station 134 can be hardened against physical or electronic tampering or removal by means known in the art.)

b. A Peripheral Database Subsystem 144 that is capable of storing, caching, and supporting the stand-alone or assisted operations of peripheral system station 134; (Peripheral DB 144 contains all information pertaining to the peripheral systems 106 in relation to allowing full operation at any one of multiple operational levels as determined by the HPs. For example, if the communications performance is not optimal, then peripheral system 106 will not be permitted to perform any new enrollments until communications with central or distributed system 102 improve. Likewise, peripheral systems 106 may permit certain types of end-users the right of entry or exit according to their own HPs, while others will not be allowed entry or exit until certain time-consuming processes are exercised as a result of a heightened state of alert which triggers an applet or intelligent agent program in the hierarchical profile for certain end-users. Similarly to reference DB 112 in central or distributed system 102, peripheral DB 144 may also be virtually compartmentalized according to HPs. Peripheral DB 144 also synchronizes with reference DB 112 in central or distributed system 102.)

c. A Peripheral Applications Subsystem 146 that performs all the operations as a result of the HPs that require checking of the local peripheral database; (This includes subsets of applications in central and distributed system 102 applications 110, including peripheral profile management 148 to synchronize information with the central profile management 118; peripheral enrollment subsystem 150 to enable peripheral systems to enroll new users and to synchronize with central enrollment subsystem 122; peripheral ID card issuing applications 152 to enable peripheral systems to issue new cards and to invalidate lost, stolen, or damaged cards and to synchronize with the central ID card issuing system 124; peripheral verification and identification application 154, which performs all the biometric verification and identification services for the end-user and administrator populations in the peripheral system, by operating on biometric inputs or data coming from the peripheral systems (Biometric input or data coming from the peripheral systems 106 could also be configured by the HPs to be processed by the central or distributed verification and identification subsystem 128.); and peripheral communications server 156 with encryption and decryption capabilities for management and coordination of exchange of information across network 104, the management of opportunistic communications for remote systems, the synchronization of central DB 112 and peripheral DBs 144, and the dissemination of profiles and profile management information.)

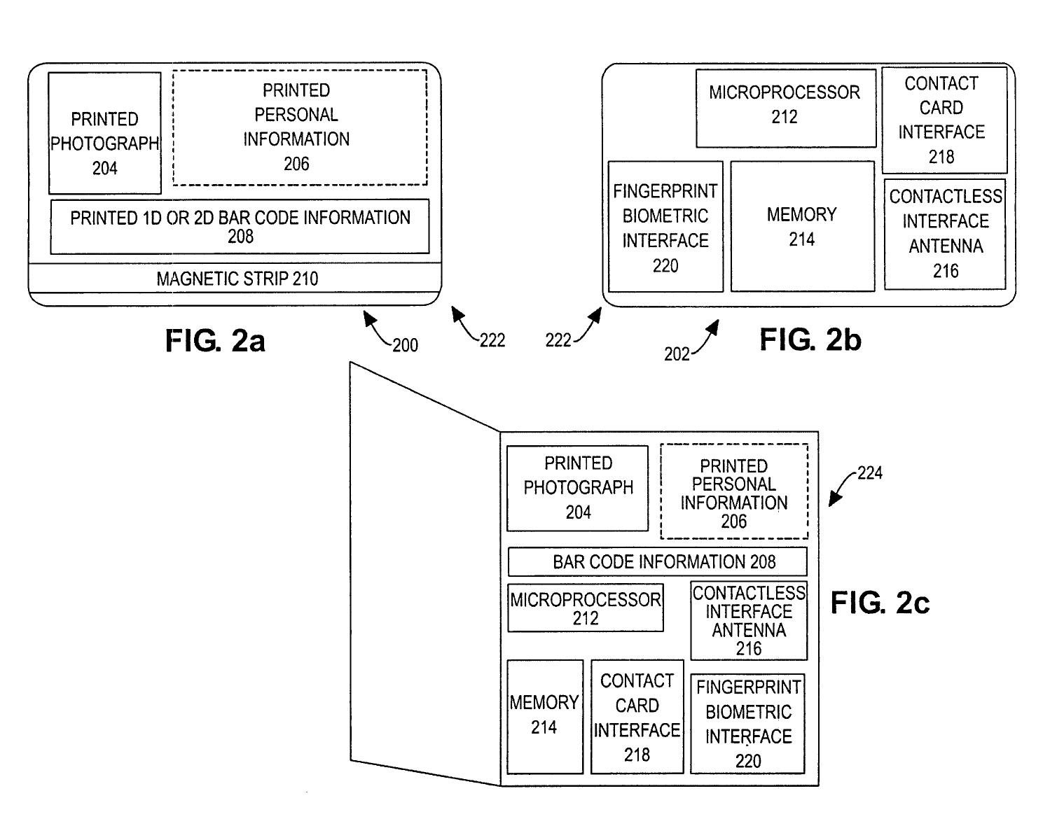

d. ID Card Subsystems 158 that are comprised of multiple implementation options of contact cards 160, contactless cards 162, and smart contact cards 164, which will be described in more detail below with reference to FIGS. 2a-2c. The ID card subsystems 158 used with the invention may include some or any of the following options:

i. encrypted and encoded printed cards with visible or invisible picture and biometric information (e.g., fingerprint, iris scan, face recognition, etc.);

ii. Encrypted and encoded magnetic cards with visible or invisible picture and/or biometric information;

iii. Encrypted and encoded holographic memory cards with visible or invisible picture and/or biometric information;

iv. Encrypted and encoded electronic chip cards with visible or invisible picture and/or biometric information;

v. Encrypted and encoded cards of any of the above that can be modified with information; and

vi. Other encrypted or encoded portable means which can carry and store information for the purposes of this system.

e. Self-Encrypting Biometric Information Subsystem 166 that allows the use of end-user or administrator fingerprints to encrypt and decrypt any or all of the information for the end-user or administrator including his personal information (i.e., picture, social security number, ID number, passport number, employee number, driver's license number, credit card number, physical characteristic information, multiple fingerprints, a primary fingerprint or set of primary fingerprints, public or private encryption keys, records of entry and exit, records of security violations, multiple encryption keys that are used according to profiles, such as dynamic encryption keys, and other biometric information, such as voice, handprint, iris scan, and the like).

Those skilled in the art understand that the principles of this invention may be implemented in any suitable mixture of component subsystems performing the same functionality as in the method and system of this invention.

Smart ID Cards and Identification Instruments in the Preferred Embodiment:

The evolution of ID card and identification instruments has surpassed the current state of biometric identification and verification systems as they have become more comprehensive in function and capability to enable more sophisticated uses for biometric systems in ingress and egress applications. The method and system of this invention seek to bridge the gap between the advancement in systems and the advancement in identification instruments by creating hierarchical profile systems that can adapt to the full array of central system functionalities, peripheral system capabilities, and the multiple capabilities arising from multiple ID card and reader systems available across large-scale systems or different classes of ID card systems that operate according to a changing or prevailing level of security.

FIGS. 2a-2c illustrate ID cards and identification instruments suitable for use with the preferred embodiment of the invention. They are suitable for large-scale verification and identification in entry/exit applications including visas, driver licenses, physical access, logical access, employee identifications, transportation passes, and so forth. These ID cards can be combined into what are now called combination ID cards that can work in contactless and contact enabled environments with fingerprint verification and/or identification. FIG. 2a illustrates a printed card 200, while FIG. 2b illustrates a chip card 202. Either of these cards can be constructed to be contactless or contact enabled. Printed cards, such as printed card 200, typically contain a printed photograph 204, printed personal information 206, a printed one-dimensional or two-dimensional bar code with information 208, and, optionally, a magnetic strip 210 with information for contact enabled applications. Printed card and magnetic card storage is more limited and can store some of the picture and personal information regarding the individual identified by or authorized to use the card. Chip cards, such as chip card 202, contain a microprocessor 212, a memory 214, a contactless interface antenna 216, an optional contact enabled card interface 218, and an optional fingerprint biometric interface chip 220 for reading fingerprints. Clearly, a fully featured chip card 202 can carry more information and perform many more ID card verification and identification functions when attached to a suitable peripheral system and central system. Each type of card 200, 202 has its own advantages and disadvantages. The best of both worlds can be obtained by combining the features into a single card. This combination card 222 would include the features of the fully optioned printed card 200 on one side, with the features of the fully optioned chip card 202 on the other side, constructed as a single combination card 222 that can be both contactless and contact enabled, plus fully featured in storage with reading and writing capability, and multiple reader compatibility in different forms.

Furthermore, for applications where other identification instruments are required, a design similar to that illustrated in FIG. 2c can be used, as exemplified for a passport or visa document 224. This document 224 can be equipped with all the options discussed previously with respect to cards 200, 202 to enable the same capabilities in document 224. Thus, document 224 can have a printed photograph 204, printed personal information 206, a printed one-dimensional or two-dimensional bar code with information 208, and, optionally, a magnetic strip 210 (not shown), a microprocessor 212, a memory 214, a contactless interface antenna 216, an optional contact-enabled card interface 218, and an optional fingerprint biometric interface chip 220.

In the preferred embodiment of this invention we assert that associated with each one of the capabilities of the fully optioned ID card 222 or document 224 (henceforth referred to collectively as ID card subsystem 158), there is a set of profiles pertinent to every user to account for every potential peripheral system that end-user will come into use of; every operating condition of the end-to-end system in matters related to performance, communications, privileges, security level, high volume, unattended operation, etc.; and available access to the central system.

Operation of System 100 in the Preferred Embodiments:

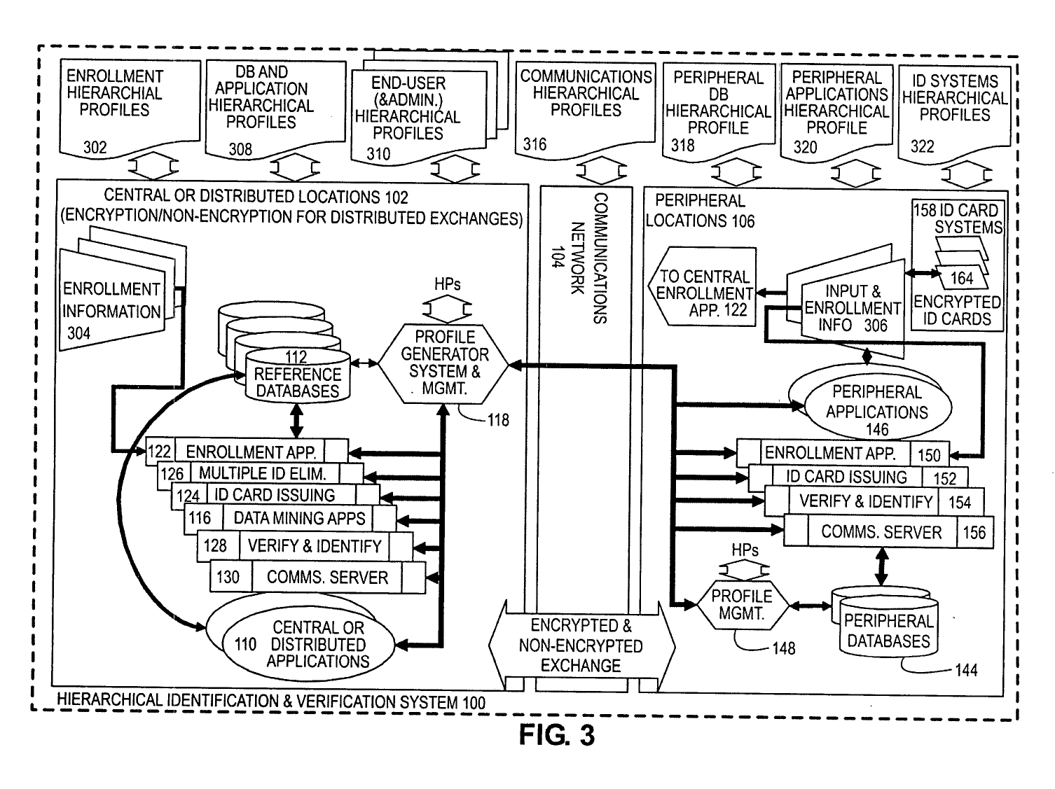

The operation of system 100 will be described herein with reference to FIG. 3. The operations of system 100 are comprised of those operations occurring at a central or distributed system location 102 where all reference databases 112 are located and where the central system applications 110 reside. The rest of the operations of the system 100 are occurring at the peripheral system locations where all operations related to end-users are happening.

Hierarchical Profiles for Static and Dynamic Operational System and User Parameters: The method of this invention relates to defining and operating a set of HPs which govern the operation of the subsystems in the large-scale biometric ingress and egress system. The term hierarchical comes from the way the operations are performed to take into account the various conditions under which system 100 has to operate to accomplish the objectives of each subsystem or transaction driven by system 100 or users of system 100 affecting end-users and administrators of the system. Profiles are defined and created to operate in a hierarchical set of preferences under which full or partial operations are performed to accomplish system objectives.

Hierarchical profiles are defined, created, and operated in the central or distributed locations 102, communications subsystems 130, 156, and the peripheral locations 106 of system 100. HPs are stored in reference databases 112 and in peripheral databases 144. HPs are also generated, modified, and enhanced in function and parameters in the central or distributed profile management and generator subsystem 118, or in the peripheral profile management subsystem 148. The central and peripheral HP management systems 118, 148, which are at the core of all application and database transactions between central system 102 and peripheral system 106 exchanges communication across the communications network 104 as part of the total communications between central or distributed systems 102 and peripheral systems 106. The following sets of HPs are defined as part of the method of this invention:

Enrollment Hierarchical Profiles 302 perform configuration operations related to mapping rules, procedures, and processes associated with the central enrollment application subsystem 122 and peripheral enrollment application subsystem 150 which are operating on central system input enrollment information 304 and peripheral enrollment information 306, respectively. Enrollment HPs create HP structures comprised of data and applets or programs (including use of intelligent agent programs), which define the parameters, and the programs that govern how enrollee-related operations are going to be conducted as part of the various processes related to each enrollee into the system. These structures and programs and their definitions will grow as other subsystems begin to operate on the information collected at enrollment time. For example, each new enrollee may undergo a background investigation process where central or distributed applications 110 are performed in foreground or background operational modes to assert the eligibility, validity, availability of privileges, operational viability, and overall ingress/egress accessibility under multiple subsystem conditions (e.g., is the end-user to be verified or identified at the peripheral level only, or does he require verification and identification at the central level? Consequently, if the central system is not available, then he cannot automatically be given ingress or egress access if he requires central level validation.)

Database and Application Hierarchical Profiles 308 comprise all the data structures and applets or programs (including use of intelligent agent programs) which define how relational database 112 is supposed to operate under various operational conditions related to supporting a user population comprised of end-users and operator administrators which cannot compromise the integrity of the system and its safeguards. For example, as we mentioned before in the discussion of FIG. 1, reference database 112 can be virtually compartmentalized so that operators can perform data and information activity mining application operations without compromising the identities of those whose patterns of activities are being investigated, or conversely, the activities of those whose identities are presented to administrators or operators at transaction time. This compartmentalization permits rules and regulations that may allow data mining applications to be launched or scheduled with the application HP 308 parameters to investigate for suspicious or illicit activities (e.g., too many ingress records without a matching egress record in a high security perimeter, visa stay violations for a tourist visa holder, excessive overseas trips for a student visa holder, no trips overseas for a student visa holder, etc.) while keeping the identity of the suspects confidential until a higher authority releases or examines the records, or a court order is issued to allow release of the suspect names. Similarly, for commercial applications, the transaction activities of those whose identifies are being verified can be safeguarded from the operators of the system.

While the data mining applications 116 determine the operations, it is still up to the database and application HPs 308 to dictate the structure of the database for all or some of the end-user population. For example, it may be determined that HPs for the DB information for end-users is compartmentalized to protect end-users but this protection is not needed for administrators and therefore it is absent in the HPs for administrators.

All applications, including enrollment 122, multiple identity elimination 126, ID card issuing 124, data mining 116, verify and identify 128, communications server 130, and other central or distributed applications 110 are configurable using DB and application HPs 308 which can include corresponding data and applet program structures. These central application HPs map the rules, policies, procedures, and controls into specific application parameters contained in mapped data structures and applet program structures so that they can effectively perform their function and affect the complete end-to-end system operation. Through the profile generator and profile management central 118 and peripheral 148 subsystems, both the initial HPs and the results of the applications are used to influence the HPs of the users 310.

User (End-user and Administrator) Hierarchical Profiles 310 fully characterize the privileges associated with end-users and administrators or operators of the system. User HPs are created at enrollment time and can be enabled even in the absence of complete information about a user (e.g., a John Doe whose biometric information is known together with other physical characteristics, but whose identity is unknown, a name or alias could be eventually obtained when an ID or other identification instrument is presented to the system for biometric identification).

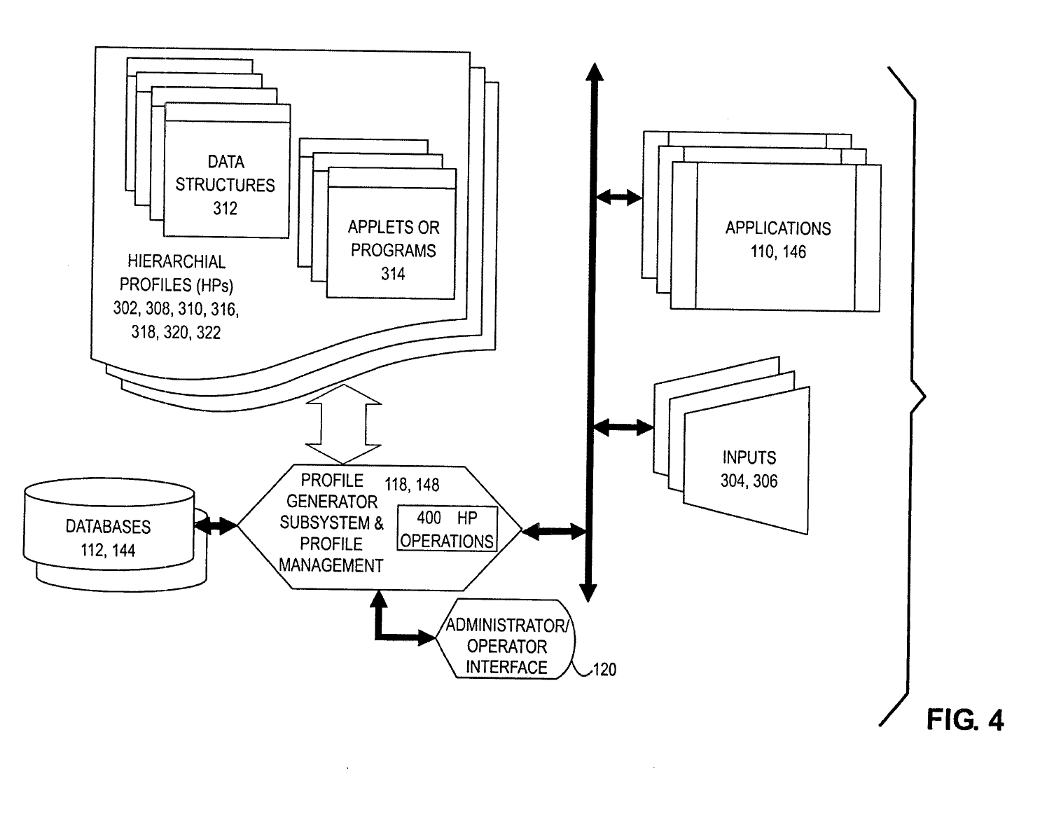

As illustrated in FIG. 4, user HPs 310 also define the type of data structures 312 and applet or program (including use of intelligent agent programs) structures 314 to be used in the profile generator and profile management subsystem 118, 148. Referring back to FIG. 3, user HPs 310 are created by administrators or they can be created, modified, or enhanced by the profile generator subsystem 118, 148 in response to applications that are running in the central or distributed systems 102, and in the peripheral systems 106. These include central system applications 110 such as enrollment application 122, multiple identity elimination 126, ID card issuing 124, data mining 116, verify & identify 128, and communications server 130. Also included are the peripheral system applications 146, such as enrollment 150, ID card issuing 152, verify & identify 154, and other peripheral applications 146.

User HPs 310 can change in response to changing conditions related to the following: End-users whose personal information, privileges, and pattern of activities show changes resulting from input data, data analysis, information patterns, applet program activations, and consolidation or reconciliation of databases. The following are examples of activities in sample applications that cause changes:

Multiple identities are discovered;

Usage of reported lost, stolen, or altered ID instruments;

Reporting of lost, stolen, or altered ID instruments;

Multiple enrollments instead of ID reissues;

Conflicting information;

Failed identifications after successful verification;

Suspicious activity, illicit activity, illegal activity, rule violation, credit violation, procedure violation, policy violation, process violation, etc;

Pattern of behavior as identified by data mining applications 116;

Data mining issued alerts;

Security level violation;

Threshold of security;

Central system changes (e.g., central system unavailable);

Communication system changes (e.g., unavailable interactive communications);

Database changes (e.g., scheduled synchronization not performed);

Busy subsystems (e.g., profile manager 118 too busy) after running central system applications; and

End-users that have been deemed non-bona-fide after administrator/operator entries into reference databases.

Communications Hierarchical Profiles 316 provide configurations to the communications network 104 to operate the various mode of communications for the multiple operating modes of the end-to-end system. The various modes of communications are implemented in the networking equipment in relation to all networking access, backbone, redundancy, backup, bandwidth allocation, bandwidth reservation, point to point communications, multicast, broadcast, wireless options (e.g., satellite, RF, broadband wireless, etc.), and the like. Communications network 104 subsystem configurations also extend to intra-peripheral system communications and intra-central or distributed system communications.

Peripheral Database Hierarchical Profiles 318 characterize configurations related to synchronizing peripheral databases 144 to the central or distributed databases 112. Once the databases 112, 144 are synchronized, then the peripheral database HPs 318 work just like the central or distributed database HPs 308.

Peripheral Applications Hierarchical Profiles 320 influence all peripheral applications, including enrollment 150, ID card issuing 152, verify & identify 154, communications server 156, and other peripheral applications 146 are configurable using corresponding data and applet program structures for peripheral applications HPs 320. These peripheral application HPs 320 map the rules, policies, procedures, and controls into specific application parameters contained in mapped data structures and applet program structures so that they can effectively perform their function and affect the complete end-to-end system operation. Through profile generator and profile management central 118 and peripheral 148 subsystems, both the Initial HPs and the results of the applications 146 are used to influence the HPs of the end-users and administrators/operators 310.

ID Systems Hierarchical Profiles 322 provide configuration guidance to the ID card systems 158 which may be using encrypted 164 or non-encrypted cards. From FIG. 1, the ID card systems come in multiple types that include smart cards 164 with contactless 162 and contact enabled interfaces 160 to receive the biometric and other information from the card. ID systems 158 also write information into the smart cards 164 as required by the central or peripheral applications 110, 146. All transactions resulting from operation of ID card system 158 are captured in the databases 112, 144 of the system 100 and how much information and what type of information is captured directly depends on the end-user HPs 310, the administrator HPs 310, and the ID card system HPs 322 effective at the time of operation. The ID card system HPs 322 are fundamental to the smooth operation of the end-to-end large-scale system since this is where all transaction events occur for ingress and egress access events.

FIG. 4 summarizes the key relationships between HPs and the main components of the system 100. It shows that HPs 302, 308, 310, 316, 318, 320, 322 consist of data structures 312 and applet or agent program structures 314 that provide operational configurations for all applications 110, 146, inputs and enrollment information 304, 306, and databases 112, 144; and are generated and maintained by the profile generation and management subsystems 118, 148. Some of the HPs are generated under the control of administrator/operator interface 120. This simplified relationship demonstrates that HPs are at the center of the methodology to enable a fully configured operational system where all subsystems are automatically loaded with the policies, procedures, rules, and processes to enable implementation of a large population and a large distributed system of this scope which could not otherwise be controlled by manual operations alone.

FIG. 4 also illustrates how the profile generation and profile management subsystems 118, 148 perform operations 400 on the HPs to create and modify HPs all over the system. These operations 400 include logical, computational, relational, neural, filtering, trend analysis, statistical, predictive, and other operations that may be required to decide how the HPs 308, 320 resulting from applications 110, 146 can cause an effect on the end-users and administrators HPs 310.

The HP Generator Subsystem and HP Management:

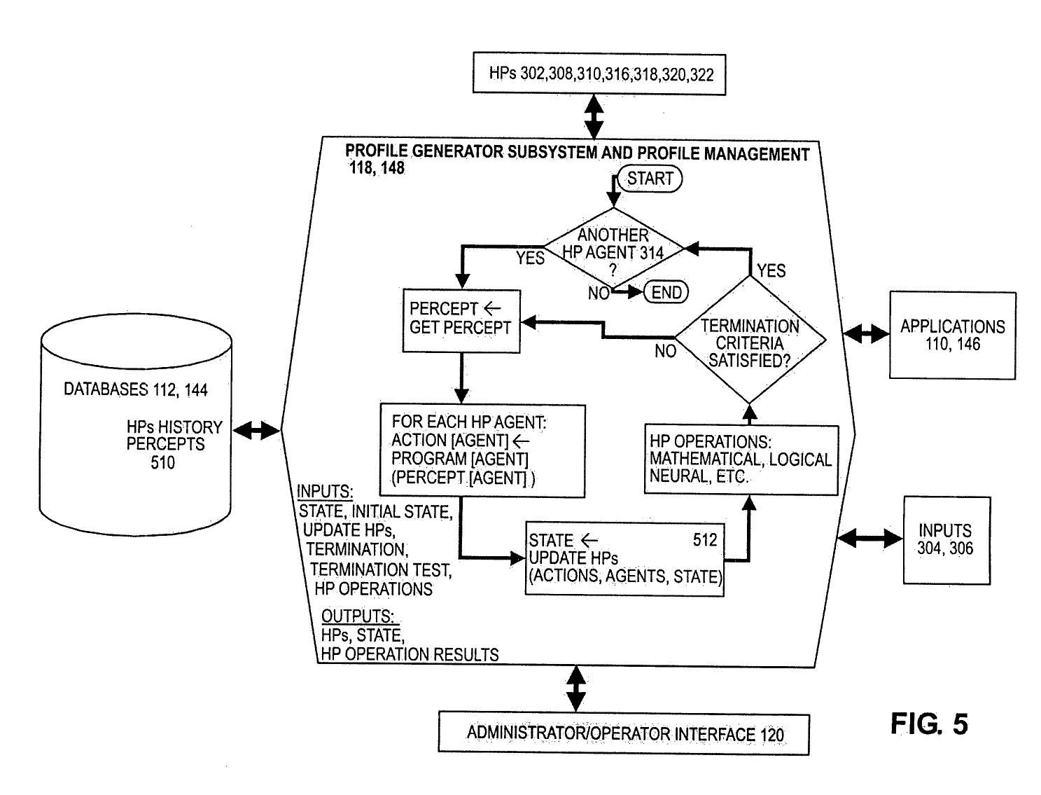

An example embodiment of the profile generation and management subsystem 118, 148 is illustrated in FIG. 5. (For purposes of the following discussion, an agent program is referred to by the name “agent”.) FIG. 5 illustrates that the profile generation subsystem and management subsystem 118, 148, processes agents and agent information, performs agent updates, generates new agents, and defines new states for these agents. Using the definitions found in the art for agents and environments (e.g., Chapter 2: Intelligent Agents, from the book Artificial Intelligence: A Modern Approach, by Stuart Russell and Peter Norvig., 1995, Prentice Hall, Inc.), an agent is comprised of an architecture and a program. In the preferred embodiment of this invention, an agent 314 is part of the architectural design of profile definitions embodied in the HPs 302, 308, 310, 316, 318, 320, 322 as comprised of data structures 312 and agent programs 314, as previously discussed with reference to FIG. 4.

Agent programs 314 in HPs 302, 308, 310, 316, 318, 320, 322 keep track of the perceptual history 510 in the ingress/egress environment, referred to hereafter as the “percept”. This percept 510, which is the saved state of each HP 302, 308, 310, 316, 318, 320, 322, is saved in the reference database 112 or the peripheral databases 144. What an agent 314 “knows” about the environment is captured in its current state 512 and its percept 510. The profile generation and profile management subsystem 118, 148 operates at least one agent 314 at a time. This agent 314 accesses the percepts 510 stored in databases 112, 144 for that particular agent 314. The percepts 510 are processed with the current state 512 of agent 314 to update HPs and perform any required HP operations. If the termination criteria of agent 314 is satisfied, agent 314 terminates. Otherwise, the process is repeated for the agent's new state 512 and updated percepts 510.

HP agents 314 can take actions in response to any percept sequence. The behavior of the HP agents 314 is based on that agent's own percept and the built-in knowledge from construction at initialization time, and modification or creation of agents 314 in the profile generation and management subsystems 118, 148. Therefore, the ingress/egress environment is completely ruled by HPs 302, 308, 310, 316, 318, 320, 322 of the end to end system 100. The agent programs 314 and data structures 312 in these HPs contain the mappings of all rules and profile information comprising the history; collective rules, policies, and regulations for system 100 and end-users of that system; the updates; and the global information of the ingress/egress environment as contained in percepts 510 and states 512 of all agents 314 in the HPs 302, 308, 310, 316, 318, 320, and 322.

Furthermore, the ingress/egress environment is generally considered accessible as all the percepts for all HPs 302, 308, 310, 316, 318, 320, 322 are available in databases 112, 144. In some cases, however, it might be considered inaccessible (e.g., due to lack of communications with the reference database 112) and, correspondingly, this condition is discerned by agents 314.

Furthermore, the ingress/egress environment is considered deterministic because the next state of every agent is determined by the current state 512, the percept 510, and the actions selected by the agent 314. This means that every agent 314 operates in a deterministic way from the point of view of the agent. In addition, because of the profile generator and management subsystem 118, 148, we consider that the ingress/egress environment of this invention is dynamic since the environment could be changing while an agent 314 is performing an action based on its available state 512 and percept 510. Accordingly, the profile generation and profile management subsystem 118, 148, performs the function of a “super” environment program or process which processes HPs 302, 308, 310, 316, 318, 320, 322, and influences how the agents 314 perform their resulting actions in each subsystem of this invention.

Subsystem Operations with Hierarchical Profiles

The various processes and objects of these processes are as follows:

Referring back to FIG. 3, the enrollment process happens every time a new user is added to the system by operation of enrollment application 122 or peripheral enrollment application 150. A new potential user of the system can be voluntary or involuntary. As part of the enrollment process, different types of information are obtained about a user and captured in the databases. This information may include some of the following information: picture, SS number, ID number, passport number, employee number, driver's license number, credit card number, physical characteristic information, multiple fingerprints, a primary fingerprint or set of primary fingerprints, multiple encryption keys that are used according to profiles (i.e., dynamic encryption keys), public or private encryption keys, records of entry and exit, records of security violations, other biometric information (voice, handprint, iris scan), etc. Furthermore, the system 100 will generate information that need not be disclosed to the end-user or the administrator and can include any of the following: identification codes, encryption codes, hashing codes, HP rule data sensors (which get activated by certain hierarchical rules), HP rule program applets (e.g., Java) which can generate data sensors for hierarchical rules, transactional target modifiable information to be updated with every transaction (e.g., as part of permanent or quasi-permanent documents such as passports, alien cards, work permit cards, contractor privilege cards, university campus privilege cards, credit cards, point cards, etc.), and tamper detection and authentication schema to render loss of an ID card or reuse of an ID card impossible via multiple means. If a user enrolls under an assumed identity, the offline multiple identity detection system can be used to deny issuance of an ID card, or by the same token, issue an ID card so that the eventually-delinquent end-user can be apprehended at the time of first use after background applications are run. Similarly, given that the primary fingerprint biometrics do not change, then the identification that occurs in real-time or as a background process or a data-mining process can be used to track the use of bogus identifications or unauthorized identification instruments.

The reference database 112 is the repository for all synchronized data and information in system 100. Database 112 is redundant and is backed up to guarantee complete integrity of the relational database 112. Furthermore, this reference database 112 is also virtually compartmentalized to account for all privileges and rules associated with the usage of data and information by the applications 110 of system 100.

The hierarchical profiles 302, 308, 310, 316, 318, 320, 322 are the objects that comprise all the static and dynamic rules under which the system operates for entry, exit, and transit operations of the large-scale verification and identification system 100 (a transit operation is defined as an intermediate checkpoint for ingress and egress within a larger physical or logical perimeter). The hierarchical profiles are named that way because they operate in a hierarchical fashion so that the highest risk end-users, actions, system-configurations, operational-environments, and other administrative factors are taken into account dynamically and automatically by the system without the use of manual administrators who may become overwhelmed by all the parameters involved and the relative priorities of those parameters, plus it also permits the administrators to run automated systems with automated rules and policies that streamline the operations of entry/exit/transient points more effectively and more thoroughly. Additionally, using the methods described herein, system 100 can be run unattended for certain types of populations prevalent in many entry/exit/transient areas such as migrant worker ports, employee entrances, contractor entrances, European Union ports providing access for EU citizens between member nations, frequent travelers that are US citizens, etc. The master copy for all HPs is contained in the central or distributed reference database 112 but the HPs also persist in the peripheral systems 106 so that they can be activated by the peripheral applications 146. Additionally, HPs are updated to all peripheral systems 106 at every opportunity according to communications and processing priorities also determined by the HPs. Furthermore, in the absence of access to central system 102, the peripheral systems 106 can operate from basic pre-defined HPs that are always present in all peripheral systems and persist under the worse operational scenarios. Conversely, the HPs themselves can also prevent peripheral systems 106 from performing certain operations if the central or distributed systems 102 are unavailable for any reason.

The data mining applications 116 are the processes used for purposes of real-time or offline mining of all user data, transactions and reference information contained in the databases 112, 144. The purpose of data mining applications 116 is to generate alerts for specific HP rule violations as configured and programmed into the mining applications 116. Mining operations also detect patterns of single end-user behavior, multiple end-user behavior, administrator behavior, location behavior, etc., as deemed necessary by the HP rule programs and as programmed into mining applications 116. Moreover, for the purposes of system 100, the mining applications 116 generate objects that are used to modify and generate new HPs which are used as the active agents at the entry, exit, and transit points where end-users and administrators use the system. Data mining applications 116 can also be used to monitor and provide accountability for the proper use and “lawful” operation of system 100 by the administrators/operators of the peripheral and central or distributed systems 106, 102. The data mining applications 116 can also be used by government agencies or system authorities interested in solutions that will aid in the detection, classification, identification, and tracking of potential foreign and domestic terrorists.

The central or distributed applications 110 are processes that work in support of peripheral systems 106 and perform the computing operations that peripheral systems 106 are not capable of supporting. In performing this function, peripheral systems 106 are dependent on the communications and networking capabilities of the system 100. The central or distributed applications 110 also incorporate the necessary periodic, recurrent, and extraordinary support of peripheral sites using any opportunistic communications capability according to the communications HP configurations so as to minimize undue dependence of peripheral systems 106 on central or distributed systems 102 and the associated communications network 104.

The peripheral databases 144 contain all the necessary information that is used by peripheral systems 106, and includes the following: synchronized referenced information, cached high-usage information, cached HPs, cached high-profile emergency information, reference HPs, updated HPs, and other input information active at any given time. The fact that the CVT system has zero FAR means that peripheral databases 144 in this large-scale system 100 are used for very targeted and specific verification and identification capabilities unlike any other system that uses any other biometric means with non-zero FAR. Additionally, the system of this invention can also be used with non-zero FAR biometrics by requiring more verification and identification processing by peripheral systems and/or central or distributed systems. Furthermore, the peripheral databases 144 also store any new peripheral enrollment information 306 which can be verified with the central reference databases 112 at a later time and then incorporated into the reference databases 112 for future use anywhere in the system.

The peripheral applications 146 are the processes that perform all the routine operations of the peripheral systems 106. The desired level of HP conformance to be achieved may cause the application requirements to exceed the capacity of peripheral applications 146 and therefore further processing capability is made available in the central or distributed sites 102. The load-sharing between central or distributed site(s) 102 and the peripheral sites 106 is also determined by the scope of the HPs. The usage of peripheral applications versus central applications is also dictated by the operational environment such as communications availability (e.g., communications services provider is down in a remote embassy location) and therefore peripheral system 106 will operate on a stand-alone basis such that when normal operations are renewed, a synchronization process becomes necessary to reconcile databases 112, 144 and to perform real-time and offline analysis of the accumulated information for regression on entry/exit/transient decisions according to remote and centrally reconciled HPs. These types of disconnected operations as determined by the HPs enable peripheral sites 106 to perform most routine operations while blocking non-routine or potentially risky operations (e.g., allowing entry on a tourist visa for a visitor born in a terrorist country without checking with the central system when there is insufficient information on the peripheral DB).

The input information 304, 306 is the data obtained from end-users and administrators that use the system at any given time. This input information is processed by peripheral system 106 and by central or distributed system 102 according to the HP configurations that are built statically and dynamically by system 100. In the case of enrollment, the operation on the input information for enrollment is coordinated with a central or distributed system 102.

The ID card subsystem 158 contains all the objects pertinent to any given user or any given administrator. All objects in ID card subsystem 158 are encrypted and comprise information as well as program applets. Additionally, the ID card used can contain public or private key encryption which includes the self-encryption coming from using primary and secondary biometric information as described previously.

### DESCRIPTIONS OF PREFERRED EXAMPLE EMBODIMENTS OF THE INVENTION

Example: Large-Scale Countrywide Ingress and Egress Border Access Control with Visa and Stay Management Through Biometric-Issued Identification Instruments

The requirements of the Homeland Defense Agency HDA (which includes the Immigration and Naturalization Service) for a Visa system with stay management is comprised of the following elements:

1. Pre-Entry Enrollment Process: This is the determination process that defines if an individual gets enrolled into the system based on eligibility requirements that include documentation requirements. This process includes a determination of approval or denial and creation of a database that includes primary and secondary biometrics and all pertinent information and preservation of documentation.

The method of this invention provides HPs that can eliminate multiple identities to guarantee that all the information captured for any given individual is associated with a unique set of primary fingerprint or secondary biometrics. The multiple-identity elimination process guarantees that the fingerprint biometrics information and the associated information in the database is the most accurate information available from the very beginning of all processes and there is no room for the creation of multiple identities that contain the same fingerprint biometric information. The process also includes the use of secondary biometrics (for example, the next top two choices, face and iris scan biometrics, as currently identified by the GAO-03-174 report). This process can also determine which are the enrollees that become “trusted” users of the system (e.g., U.S. citizens that are frequent travelers, immigrant aliens that are permanent residents, citizens of countries that do not require a visa to enter the U.S. because they have bona-fide documents at U.S. standards, and any other non-immigrant aliens as selected by the HDA), and also “non-trusted” users of the entry enrollment system. We define “trusted” and “non-trusted” to describe all individuals that by the nature of their HDA definition (e.g., U.S. citizens that are frequent flyers, or as in the current list of countries whose citizens are required to be fingerprinted for any U.S. visa applications, respectively) or other pertinent HDA or law-enforcement characteristics will be required to perform only a verification process through the use of an identification card token and/or an identification process at the points of entry (POEs). Therefore, we incorporate in this solution as part of the process, an identification document token (e.g., visa, passport card, identification pass, etc.) henceforth referred as a “POE ID Card (POEIDC)” that contains encoded and encrypted biometric templates and information as obtained during the enrollment process. (The POEIDC also incorporates, if desired, the capability to record information on the card itself.) The POEIDC is also enabled to have HPs for the end users describing complete configuration attributes under which they will be allowed to enter or exit and perform the necessary transactions associated with their status.

The POEIDC becomes a trusted instrument with encoded and encrypted information that includes the biometric templates to be used for the verification process at the POE. Even if the POEIDC is lost or stolen, it cannot be used by any other individual because of the encryption, all the FAR=0 biometric template information built into the card, and the automatic safeguards built into the end-user HPs specific to that end-user. Additionally, any POE can issue a new POEIDC through a new enrollment process. The new enrollment is based on the biometric identification of the individual's identity which relates him to the original enrollment process and through the configuration of subsystem HPs computed with the end-user HPs of record. If the HPs computed during the new enrollment process correspond with the end-user's HP's of record, then the reissue process goes ahead.

2. The Entry Process: This is the process related to the management of travelers at POEs with an accurate and timely capability of the entry process. The improvements required over the prior art include efficiency, efficacy, and consistency in detecting fraudulent travel documents through the use of biometrics for the verification and identification process. The end-user HPs provide the automatic policies, rules, procedures, and controls that are needed for the end-user when the POEIDC is processed by the ID card system at peripheral systems.

The example system in this embodiment provides for a complete “1-tomany” fingerprint biometric matching process based on FAR=0 CVT fingerprint matching. This CVT also builds on multiple-identity elimination and provides for accurate and efficient verification (1-to-1 matching) or identification (1-to-many matching) of all the “trusted” individuals which because of their end-user HPs are only required to perform a verification, while “non-trusted” individuals as characterized by their end-user HPs are required to undergo both verification and identification. For “non-trusted” individuals the end-user HPs and other watch list HPs can influence the ID card system to perform any of multiple degrees of verification and identification as in the following examples:

Automatic Identification against a fingerprint biometrics database that is maintained locally or remotely;

Automatic Verification and Identification against a fingerprint biometrics database that is maintained locally or remotely;

Automatic Cross-verification against a fingerprint biometrics database of agency violators of any kind which is maintained locally or remotely;

Manual or automatic Cross-verification against a facial biometrics database of agency violators of any kind which is maintained locally or remotely; and

Configurable and Selectable Verification and Identification configurations and dynamic settings for the “non-trusted” threshold for any categories or types of operation resulting in dynamic HPs according to dynamically selectable HDA or law-enforcement agency administrator or operator selectivity criteria (e.g., “homeland defense” alert levels, volume of travelers, country of origin of the travelers being processed, etc.)

Both “trusted” and “non-trusted” individuals can be checked against the “watch lists” which contain dynamically updated entries for comparison as part of the verification (& identification) and validation process before any individual is allowed to enter or exit the country.

All information obtained from the entry process for all travelers will be incorporated into the database and pertinent information for all valid immigrant and non-immigrant travelers can be checked as part of the stay management process described below (e.g., checking to see if the immigrant alien with permanent resident status has not violated the maximum one-year stay outside the U.S. and whether he has renovated his permanent resident visa in the last ten years).

3. The Exit Process: This is the process related to capturing, recording, and reporting the traveler departure information so that it becomes part of the databases associated with the stay management process.

The end-user HPs can characterize the operations required for “trusted” individuals which are only required to perform a verification or identification process at the peripheral system. Another set of individuals in the “non-trusted” category as defined previously, will be required to go through a more thorough verification and identification (1-to-many matching) process that not only uses the POEIDC to verify the individual but will perform any of multiple degrees of verification and identification as in the following examples:

Automatic Identification against a fingerprint biometrics database that is maintained locally or remotely;

Automatic Verification and Identification against a fingerprint biometrics database that is maintained locally or remotely;

Automatic Cross-verification against a fingerprint biometrics database of agency violators of any kind (e.g., law enforcement agency violators) which is maintained locally or remotely;

Manual or automatic Cross-verification against a facial biometrics database of agency violators of any kind which is maintained locally or remotely; and

Configurable and Selectable Verification and Identification configurations and dynamic settings for the “non-trusted” threshold for any categories or types of operation according to dynamically selectable HDA or law-enforcement agency selectivity criteria (e.g., “homeland defense” alert levels, volume of travelers, ten-most wanted search, country of origin of the travelers being processed, and the like).

Both “trusted” and “non-trusted” individuals can be checked against the “watch lists” which contain dynamically updated entries for comparison as part of the verification (& identification) and validation process before any individual is allowed to exit the country.

The exit management process also generates entries into the HDA database associated with any valid enrollee of the Visa and stay management system. This information now becomes the object of operations performed by the stay management process which is under the category of other applications in the central or distributed system and in the peripheral system. The rules, policies, procedures, and controls entered by the administrators of the system are translated into HPs to create the lists of non-immigrant visa violators and permits the tracking, monitoring, reporting, and alerting by the HDA and related agencies responsible for the operation and administration of the end-users.

4. The Stay Management Process: This is the process related to the management of all immigrant and non-immigrant aliens in relation to their stays in the U.S. once they become part of the enrollment and entry/exit processes and the associated databases.

All transaction information generated at transaction times through enrollments and primary and secondary entry/exits is captured by the system becoming part of the distributed database captured for the purposes of Stay Management Applications. Furthermore, Biometric information, personal information, and “transaction” information only comes together for purposes of visa and stay management system HDA-related applications and operations.

Extensions of Stay Management into Other Agencies and for Aliens already in the U.S.: Stay Management Applications can be extended to interact with other agencies such as Department of Transportation and the Department of the Treasury to create stronger stay-management-related requirements for issuing new driver licenses and social security cards, respectively. This can be done by extending the use of identification instruments as in the examples of FIGS. 2a-2c, and using these instruments with the compartmentalized information in the databases so that one agency can perform its mission under the law, while another agency is compartmentalized to perform its own mission under the law, but all information is part of the relational database that when required can come together under the proper application (e.g., data mining) and proper authority (e.g., HDA rule, court order, or the like) to manage more transactions with the same end-user information as tracked from common identification instruments with linked information. Moreover, the stay-management process can begin to be applied retroactively to all current immigrant and non-immigrant aliens in the U.S. so that through new “homeland security” legislation, any new driver license renewals will require an alien enrollment process with biometrics so that driver licenses or other “renewables” have a POEIDC requirement for any alien wishing to obtain or renew these licenses.

Those skilled in the art understand that the principles of this invention may be implemented in other suitably similar examples of large-scale access for ingress and egress with biometric identification instruments as in the above embodiments using the same method and system of this invention. These examples extend into large-scale commercial driver and vehicle identification for ingress and egress access control and monitoring using biometrics; large scale populations in commercial or government buildings with multi-tiered security perimeters using biometric identification instruments for physical and logical access and tracking of entry, exit, transit, and stay management in highly secured areas; and other large scale population and complexity of scope rules, policies, procedures, and controls that must be accounted for automatically and dynamically by HPs as in the method and system of this invention.

While specific embodiments have been illustrated and described in this specification, those of ordinary skill in the art appreciate that any arrangement that is calculated to achieve the same purpose may be substituted for the specific embodiments disclosed. This disclosure is intended to cover any and all adaptations or variations of the present invention, and it is to be understood that the above description has been made in an illustrative fashion, and not a restrictive one. Combinations of the above embodiments, and other embodiments not specifically described herein will be apparent to those of skill in the art upon reviewing the foregoing disclosure. The scope of the invention should properly be determined with reference to the appended claims, along with the full range of equivalents to which such claims are entitled.

The invention claimed is:

1. A system for controlling access of an individual to an area, the individual having a unique biometric identifier, said system comprising:
a computer in communication with a database, said database having stored biometric identifier information contained therein;
a profile-generation application executable by said computer, said profile-generation application automatically generating a profile for the individual, said profile comprising at least one rule for controlling access to the area by the individual; and
a verification application for comparing said individual biometric identifier with said stored biometric identifier information in said database for determining whether to allow access to the area to the individual as in accordance with said at least one rule.

2. The system of claim 1 further including an enrollment application executable by said computer for transferring said individual biometric identifier to said database for enrolling the individual in the system.

3. The system of claim 1 wherein there are one or more additional applications executable by said computer and said profile-generation application changes said profile for the individual in response to the results of said one or more additional applications.

4. The system of claim 3 wherein said one or more additional applications comprise a data mining application that searches said database to correlate activity patterns of the individual for determining whether a rule violation has occurred.

5. The system of claim 1 further including an identification instrument issued to the individual, said identification instrument containing the biometric identifier of the individual, whereby the individual may present the identification instrument for verification.

6. The system of claim 5 wherein said computer is a central computer and said database is a central database, said system further including a peripheral station having a peripheral computer in communication with said central computer and said central database, said peripheral computer being in communication with a peripheral database, whereby a reader is in communication with said peripheral station for reading said individual biometric identifier stored in said identification instrument, and whereby, if said peripheral computer is unable to communicate with said central computer for verification, access to the area is denied to the individual.

7. The system of claim 1 wherein said computer is a central computer and said database is a central database, said system further including a peripheral station having a peripheral computer in communication with said central computer and said central database, said peripheral computer being in communication with a peripheral database, whereby an enrollment application is executable by said peripheral computer for transferring said individual biometric identifier to said peripheral database for enrolling the individual in the system, and whereby said peripheral database is automatically synchronized with said central database for completion of enrolling of the individual.

8. A method for controlling access of an individual to an area, said method comprising:
enrolling the individual for access to the area by obtaining personal information, including personal biometric information, from the individual;
generating a profile comprising at least one rule for controlling the individual's access to the area; storing activity data of the individual in a database;
performing data mining of said database to detect a pattern of activity by the individual, whereby said data mining produces a result; and
automatically generating a new profile comprising at least one rule for controlling the individual's access to the area based on said result of said data mining.

9. The method of claim 8 further including the step of providing the individual with an identification instrument, said identification instrument including said personal biometric information to aid the system in verifying the identity of the Individual.

10. The method of claim 9 wherein said step of storing activity data includes storing a record of transactions performed by the individual when using said identification instrument to access the area.

11. The method of claim 9 wherein said personal biometric information comprises fingerprint data, and said identification instrument is a smart card containing encoded fingerprint data of said individual.

12. A method for controlling access of an individual having a personal biometric identifier to an area, said method comprising:
providing the individual with an identification instrument, said identification instrument containing said personal biometric identifier;
providing a database containing stored biometric identifier information, said stored biometric information including said personal biometric identifier of said individual;
automatically generating a profile comprising at least one rule for controlling access of the individual to the area;
applying said at least one rule when comparing said biometric identifier contained in said identification instrument with said biometric information in said database to verify the authenticity of said identification instrument for determining whether to grant access to the area to the individual.

13. The method of claim 12 further including the step of providing said identification instrument with a microprocessor, wherein said personal biometric identifier comprises fingerprint data, and said identification instrument is a smart card containing encoded fingerprint data of said individual.

14. The method of claim 12 further including the step of 6 virtually compartmentalizing said database so that an operator can perform data mining operations on said database without compromising an identity of an individual whose pattern of activity is under investigation.

15. A hierarchical system for controlling ingress and egress to an area by an individual having a biometric identifier, said system comprising:
a reference database containing stored biometric identifier information;
a computer in communication with said database;
a biometric identifier information input;
an enrollment application executable by said computer for storing enrollment information in said reference database, said enrollment information including said biometric identifier information of the individual; and
a profile generator application executable by said computer for automatically generating a hierarchical profile in response to said enrollment information, whereby said generated hierarchical profile comprises at least one rule for controlling the individual's ingress and egress to the area, whereby the system will automatically control the ingress and egress of the individual to the area on the basis of said hierarchical profile when the individual's said biometric information is presented to said biometric information input unit.

16. The system of claim 15 further including a data mining application executable by said computer, said data mining application monitoring an access activity of the individual to the area for determining if said access activity constitutes a rule violation.

17. The system of claim 16 wherein if said access activity constitutes a rule violation, said data mining application issues an alert and said profile generator application generates a new hierarchical profile for the individual.

18. The system of claim 15 wherein said system includes a central system and a peripheral system, and wherein said reference database is a central database and said computer is a central computer, and said peripheral system includes a peripheral database and a peripheral computer, whereby said peripheral computer is enabled to receive said enrollment information and transfer said enrollment information to said peripheral database for generating an initial hierarchical profile comprising at least one rule controlling the individual's ingress and egress to the area, and whereby said enrollment information is transferred to said central computer For generating a new hierarchical profile comprising at least one rule regarding the individual's ingress and egress to the area.

19. The system of claim 15 further including an identification instrument containing said biometric identifier information of the individual, said identification instrument being capable of communicating said biometric identifier information to the system in a contactless manner.

20. The system of claim 15 wherein said database is virtually compartmentalized so that an operator can perform data mining operations without compromising the identity of an individual whose pattern of activity is being investigated
